(19) United States
(12) Patent Application Publication
(10) Pub. No.: US 2015/0147454 A1
(43) Pub. Date: May 28, 2015

(54) CHEWY EDIBLE COMPOSITIONS WITH EXPANDED TEXTURE

(71) Applicant: NESTEC SA, Vevey (CH)

(72) Inventor: John Kenyon Russell-Maynard, Orange (AU)

(21) Appl. No.: 14/548,372

(22) Filed: Nov. 20, 2014

Related U.S. Application Data
(60) Provisional application No. 61/908,448, filed on Nov. 25, 2013.

(51) Int. Cl. A23K 1/16; A23K 1/00; A23K 1/18

(52) U.S. Cl. CPC A23K 1/1631; A23K 1/1846; A23K 1/003
USPC 426/576

(57) ABSTRACT

Methods and compositions are provided for producing a high glycerol/high collagen or gelatin edible composition having a variety of textures and features, suitable for use as a pet treat. Chewy edible compositions produced by such methods are also provided.

### CROSS REFERENCE TO RELATED APPLICATIONS

This application claims priority to U.S. Provisional Application No. 61/908,448 filed Nov. 25, 2013, the disclosure of which is incorporated herein by this reference.

### BACKGROUND OF THE INVENTION

1. Field of the Invention

The invention relates generally to food compositions and particularly to highly palatable, chewy compositions with a porous, expanded texture resulting from leavening the product prior to cooking, particularly suitable for use as pet treats.

2. Description of Related Art

Collagen hydrolysate (“gelatin”), sugar, and water mixtures have been used in the confectionary business to form “jelly confectionaries,” which are soft and friable, offering little resistance to chewing. To achieve a denser, more chewable, rubbery product, a humectant/plasticizer such as glycerol or sorbitol is often used as a locking agent to bridge across the gelatin triple helix structure to make it more rigid. In this manner, glycerol plays a competing role against the sugar and water since the latter two function to increase the softness of the product.

On an industrial scale, it is difficult to achieve rigidity by merely reducing sugar and water levels in a high glycerol-gelatin mixture because the result would be a highly viscous, sticky and very difficult to handle composition with poor mixing and pumping properties. Indeed, food products that contain gelatin and glycerol (e.g., rolled fondant icings) typically also contain a large amount of sugar, as well as water, fats or oils, to facilitate manipulation of the material. Current techniques typically require hand-kneading or, if mechanized, mixing at high temperatures or using complex high torque equipment such as extruders to manufacture confectionaries having desired levels of rigidity. These known techniques require considerable capital and large factories to implement. Furthermore, resultant products generally have restricted form and as a result, problems arise in molding the products to a desired shape while still maintaining other desired characteristics of the product, such as palatability and chewing duration.

There is, therefore, a need for improved techniques for processing and handling blends of gelatin, humectants and/or related polymers.

### SUMMARY OF THE INVENTION

It is, therefore, an object of the present invention to provide techniques for processing and handling high-viscosity gelatin blends, humectant blends, and other polymer mixtures in strong hydrogen-bonding solvents.

It is another object of the invention to provide edible, chewy compositions for use as pet treats, which can be molded and formed into a wide variety of shapes and unique textures by using simple methods on either a small, bench-top scale or a large, industrialized scale, resulting in improved animal enjoyment and owner interaction, as well as decreased manufacturing costs.

It is another object of the invention to provide a method of preparing and delivering edible treats for pets by molding the product inside its final packaging rather than the conventional technique of requiring a separate manufacturing step and sequentially, a separate packaging step.

It is another object of the invention to provide a method for preparing an expanded, low-calorie, long-chewing duration treat for pets, resulting in improved animal enjoyment and health benefits.

One or more of these or other objects are achieved by the methods of the present invention, and the compositions produced thereby, the methods comprising preparing a mixture of glycerol, collagen or a collagen derivative, and a leavening agent, under chilled process conditions to produce an easily manipulable, pourable paste, and cooking and cooling the paste to form a chewy edible composition with unique shapes and textures, suitable for use as a pet treat.

Other and further objects, features, and advantages of the present invention will be readily apparent to those skilled in the art.

### BRIEF DESCRIPTION OF THE DRAWINGS

FIGS. 1A-1C are photographs of two embodiments of the chewy edible compositions having an expanded texture and layered with jerky layers. FIG. 1A shows a simple rectangular composition that can be formed by layering one layer of jerky material, cooking and cooling the composition, and dividing a large form of the composition, such as produced in a cake pan or cookie sheet, e.g. by cutting with a knife; FIG. 1B shows a “sandwich” composition made by cooking the leavened pourable paste with two layers of jerky. FIG. 1C shows a close-up of the composition of FIG. 1B.

FIG. 2 is a photograph of a dual-density chewy edible compositions prepared as described in Example 3. The pourable paste (with leavening agent) was placed into a mold and heated at 75-85° C. for an extended period. When the bottom layer became transparent/translucent to the desired extent; the mould was removed from the oven and cooled.

FIG. 3 is a photograph showing three different views of a leavened chewy edible composition prepared as described in Example 4. The pourable paste was poured into a small, shaped molds and heated in an oven at 75-85° C. for one to two hours to form a cooked product. The mixture expanded dramatically during the heating process. The mold containing the cooked product was removed from the oven and cooled slowly, causing the product to de-gas in the center and to collapse, forming a depression in the center.

FIG. 4 is a photograph showing a leavened chewy edible composition prepared as described in Example 4, using an animal or fish digest in the liquid pre-mix to form a highly palatable pet treat.

### DETAILED DESCRIPTION OF THE INVENTION

### Definitions

All percentages expressed herein are by weight of the total weight of the composition unless expressed otherwise.

All ratios expressed herein are on a weight:weight (w/w) basis unless expressed otherwise.

Ranges are used herein in shorthand, so as to avoid having to list and describe each and every value within the range. Any appropriate value within the range can be selected, where appropriate, as the upper value, lower value, or the terminus of the range. As used herein, the singular form of a word includes the plural, and vice versa, unless the context clearly dictates otherwise. Thus, the references “a”, “an”, and “the” are generally inclusive of the plurals of the respective terms. For example, reference to “a method” or “a food” includes a plurality of such “methods” or “foods.” Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The term “comprising” is intended to include embodiments encompassed by the terms “consisting essentially of” and “consisting of.” Similarly, the term “consisting essentially of” is intended to include embodiments encompassed by the term “consisting of.”

The methods and compositions and other advances disclosed herein are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

The term “humectant” as used herein refers to substances that absorb or help other substances retain moisture. Substances such as glycerol are sometimes referred to both as humectants and as plasticizers. The role of glycerol, or other substances that can substitute for glycerol as detailed herein, in the present invention is as a locking agent to bridge across the gelatin structure to add density and strength.

For avoidance of doubt, the term “glycerol,” as used herein, refers to propane-1,2,3-triol (IUPAC), and may also be known to the skilled person as glycerin, glycerine or propanetriol. Glycerol is a simple polyol (sugar alcohol) compound. It is a colorless, odorless, viscous liquid. Glycerol contains three hydroxyl groups that are responsible for its solubility in water and its hygroscopic nature.

The term “collagen” refers to a group of naturally occurring proteins found in animals, especially in the flesh and connective tissues of vertebrates. Collagen is composed of a triple helix of polypeptide chains. In the form of elongated fibrils, collagen is is mostly found in fibrous tissues such as tendon, ligament and skin, and is also abundant in cornea, cartilage, bone, blood vessels, the gut, and intervertebral disc. The term “collagen derivative” refers to a substance that has been produced or derived from collagen. An exemplary form of collagen derivative is gelatin, Gelatin (or gelatine) is a translucent, colorless, brittle (when dry), flavorless solid substance composed of a mixture of peptides and proteins produced by partial hydrolysis of collagen extracted from various animal by-products. It is commonly used as a gelling agent in food, pharmaceuticals, photography, and cosmetic manufacturing. Gelatin is an irreversibly hydrolyzed form of collagen, and is classified as a foodstuff. It is found in most gummy candies as well as other products such as marshmallows, gelatin dessert, and some ice cream, dip and yogurt. Household gelatin comes in the form of sheets, granules, or powder.

The term “leavening agent” refers to any one of a number of substances used in doughs and batters to cause a foaming action that lightens, softens, or otherwise alters the texture of the finished product. The leavening agent typically incorporates gas bubbles into the dough. The gas may comprise air incorporated by mechanical means, but usually it is carbon dioxide produced by chemical or biological agents.

When referring to the edible composition of the invention, the term “solid,” or “solid, three-dimensional,” may be used. These terms are not intended to limit the nature of the product by way of its texture, porosity, hardness, chewiness, or any other such parameter. They are instead intended to distinguish the compositions from substantially flat films (e.g., gelatin films or hollow compositions (e.g., gelatin capsules) made from such films.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

The invention springs in part from the discovery that mixtures such as gelatin (or collagen) and humectants such as glycerol can be used to produce chewy edible compositions by mixing the components at cold temperatures. Surprisingly, it was found that mixing such components at or near the freezing point of water decreases viscosity and facilitates ease of handling, rather than having the previously expected opposite effect. It was further discovered that the introduction of gas bubbles, e.g., by way of mechanical leavening or additional of a leavening agent, enables the production of fmal products with an expanded texture. Moreover, the mixtures can be manipulated during the heating and/or cooling process to produce a variety of unique textures and shapes.

Thus, one aspect of the invention features a method for preparing a chewy edible composition, comprising: (1) preparing a liquid pre-mix by mixing a humectant with other liquid ingredients, if any; (2) preparing a dry pre-mix by mixing collagen or a collagen derivative with other dry ingredients, including, but not limited to, leavening agents if leavening is accomplished by non-mechanical means; (3) chilling the liquid pre-mix and the dry pre-mix to a temperature between about −15° C. to about 7° C.; (4) mixing the liquid pre-mix with the dry pre-mix at a temperature between about −15° C. to about 7° C. to form a pourable paste; (5) optionally, subjecting the pourable paste to mechanical levening; (6) pouring the paste into a heat-stable container; (7) heating the container at a temperature and for a time sufficient to produce a cooked paste; and (8) cooling the cooked paste to form the chewy edible composition with expanded texture. As discussed in greater detail below, the heating and/or cooling steps can be manipulated to produce unique shapes and textures in the final composition.

Glycerol is preferred for use as a humectant in the present invention. However, many other substances can substitute for glycerol in the compositions of the invention. Substances that have been tested and found suitable include erythritol, 1,2-propanediol (any isomer), ethanol and sorbitol. Other substances that are suitable include, but are not limited to: threitol; dihydroxyacetone; 1,3-propandiol (any isomer); 1,2,3-butanetriol (any isomer); 1,2,4 butanetriol (any isomer); 1,2 butanediol (any isomer); 2,3 butanediol (any isomer); arabitol; xylitol; ribitol; mannitol; galactitol; fucitol; iditol; inositol; volemitol; isomalt; maltitol; lactitol; maltotriitol; maltotetraitol; polyglycitol; polyethylene glycol (PEG) (all chains lengths) and non-toxic PEG derivatives including methoxy polyethylene glycols; sugar alcohols; all other non-toxic diols or triols preferably with low melting point; hydrogenated sugars or sugar derivatives including hydrogenated starches; non-toxic aminoalcohols preferably with low melting point; and all related diols and triols derivatives including esters, ketone or aldehydic derivatives, e.g. ethyl 2,3-dihydroxypropanoate. For ease of reference, the formulations typically are disclosed with reference to glyercol as the humectant; however, one or more, or combinations of, the above-listed humectants can be used in place of glycerol.

The liquid pre-mix is prepared by providing glycerol (or other humectants) alone, or mixing it with at least one other liquid pre-mix ingredient that can include, but is not limited to, sugar, sugar alcohols, water, pre-prepared sugar-water syrups, and flavor enhancers. The liquid pre-mix can be prepared with heating, if necessary. Sugars are selected from any sugar or sugar mixture. Typical sugars include glucose, fructose, maltose and sucrose, to name a few. Other suitable sugars can include any edible substance, both aldoses and ketoses and all isomers there of, with the chemical structure Cx(H₂O)y; for instance dihydroxyacetone, glyceraldehydes; ribose, deoxyribose, arabinose, xylose, ribulose; erythrose; mannose; sorbose; galactose; fucose; idose; inosose; levulose; ribulose; isomaltose; lactose; sedoheptulose, manmoheptulose; i.e., generally all non-toxic sugars including trioses, tetroses, pentoses, hexoses and heptoses; amino-sugars including glucosamine; whey powder; all types of milk powder; and sugar derivatives including sucralose; palm sugar; coconut sugars and inulin., or any combination of the foregoing The sugar alcohol can be any sugar alcohol used in food preparation, for instance, sorbitol [arabitol; xylitol; ribitol; mannitol; galactitol; fucitol; iditol; inositol; volemitol; isomalt; maltitol, lactitol, or combinations thereof. The pre-prepared sugar-water syrups may comprise glucose syrup, golden syrup, natural syrups such as maple syrup, or agave syrup, and honey, to name a few. Other syrups include treacle; molasses; sucrose syrup; high fructose corn syrup, invert syrup (fructose and glucose syrup); hydrogenated starch syrup; condensed milk; all milk syrups including whey syrup; permeate concentrate; whey ultrafiltrate concentrate syrup; fruit concentrate syrups/nectars; fruit juices and concentrates; malt syrups and malt concentrates; palm sugar syrup; sorghum syrup; agave nectar; barley malt syrup; birch syrup; brown rice syrup; corn syrup; kithul treacle; sugar beet syrup; stevia; chicory extract; yacon syrup, and any combination of the foregoing. The flavor enhancers can include any naturally occurring or manufactured palatant, including animal or fish digests, salt, Worcestershire sauce, hickory smoke liquid, bacon aroma; beef stock powder; vegemite; SPA (Halycon proteins Vic Australia), and combinations thereof, to name a few. The liquid pre-mix can also comprise micronutrients such as vitamins and minerals to provide additional nutritional value to the edible composition.

The liquid pre-mix should be formulated such that the water content (including the water contained in any syrup or liquefied sugar), does not exceed about 50% of the pourable paste formed when the liquid and dry pre-mixes are combined. In particular embodiments, the water content of the pourable paste is less than about 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2% or 1%. In other embodiments, the water content of the pourable paste is up to about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50%. In particular embodiments, the water content of the pourable paste is between about 0% and about 50%, or between about 5% and about 45%, or between about 10% and about 40%, or between about 15% and about 35%, or between about 20% and about 30%, or between about 0% and 20%, or between about 0% and 15%, or between about 0% and 10%, or between about 0% and 5%. It is noted that lower moisture products can be stronger and/or have higher melting points.

The liquid pre-mix should also be formulated such that the humectant content is between about 15% and about 40% of the pourable paste formed when the liquid and dry pre-mixes are combined. In certain embodiments, the humectant content of the pourable paste is at least about 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38% or 39%. In other embodiments, the humectant content of the pourable paste is less than about 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17% or 16%. In certain embodiments, the humectant content of the pourable paste is between about 15% and about 40% as mentioned above, or between about 20% and about 35%, or between about 25% and about 30%.

Separately, a dry pre-mix comprising collagen or a collagen derivative and optional leavening agents is also prepared. The dry pre-mix may comprise additional ingredients, for instance, natural or artificial acidifying agents, antioxidants, flavor enhancers, preservatives, colorants, and other nutritional components such as starches and flour.

Leavening agents may include any leavening agent used in the art, including various combinations of acids and bases, including but not limited to citric acid, tartaric acid, phosphoric acid, sodium aluminium phosphate (also known as sodium acid phosphate), sodium acid pyrophosphate, monocalcium phosphate and the like, combined with sodium bicarbonate, potassium carbonate, or the like. In particular embodiments, the leavening agent may include sodium bicarbonate, or combinations of sodium bicarbonate and citric acid, sodium bicarbonate and tartaric acid, sodium bicarbonate and phosphoric acid, and sodium bicarbonate and sodium acid phosphate (baking powder). The amount of leavening agent that can be included in the dry pre-mix will depend on the type of leavening agent(s) being utilized and the nature of the desired outcome. Such amounts can be easily calculated by the person of skill in the art, or determined empirically. In another embodiment, leavening is accomplished through the use of a biological agent, such as yeast, to produce a fermented mass such as is used the manufacture of bread or other doughs. The fermented mass is then mixed into the cold paste.

Alternately the cold paste can be whipped to incorporate gas into the paste. Such mixing of air should be done at the chilled temperatures described above, with care taken to avoid excessive shear. Alternatively, gas can be bubbled into the cold paste before heating whereas it behaves in a manner similar to the above chemical leavening agents, or into the melted material during the cooling step. In the latter embodiment, the size of the bubbles can be large, though not as evenly distributed as bubbles generated by mechanical, chemical or biological agents used to treat the cold paste.

In a particular embodiment, sorbic acid is included in the dry pre-mix. In another embodiment, an antioxidant such as NATUROX™ is included. In another embodiment, a flour, such as rice bubble flour, is included. In another embodiment, titanium dioxide is included. The dry pre-mix can also comprise micronutrients such as vitamins and minerals to provide additional nutritional value to the edible composition.

The dry pre-mix should be formulated such that the collagen or collagen derivative content is between about 20% and about 65% of the pourable paste formed when the liquid and dry pre-mixes are combined. In certain embodiments, the collagen or collagen derivative content of the pourable paste is at least about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, or 64%. In other embodiments, the the collagen or collagen derivative content of the pourable paste is less than about 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%40%, 39%, 38%, 37%, 36%, 35%, 34%, 33%, 32%, 31%, 30%, 29%, 28%, 27%, 26%, 25%, 24%, 23%, 22%, or 21%. In certain embodiments, the the collagen or collagen derivative content of the pourable paste is between about 20% and about 65% as mentioned above, or between about 25% and about 60%, or between about 30% and about 55%, or between about 35% and about 50%, or between about 40% and about 45%.

The liquid pre-mix and the dry pre-mix are chilled to the specified temperature range prior to mixing. The appropriate temperature range is between about −15° C. and about 7° C. In particular embodiments, the temperature range is between about −15° C. and about −14° C., or about −13° C., or about −12° C., or about −11° C., or about −10° C., or about −9° C., or about −8° C., or about −7° C., or about −6° C. or about −5° C. or about −4° C. or about −3° C. or about −2° C. or about −1° C. or about 0° C. or about 1° C. or about 2° C. or about 3° C. or about 4° C. or about 5° C. or about 6° C. or about 7° C. In other embodiments, the temperature range is between about −15° C., or about −14° C., or about −13° C., or about −12° C., or about −11° C., or about −10° C., or about −9° C., or about −8° C., or about −7° C., or about −6° C. or about −5° C. or about −4° C. or about −3° C. or about −2° C. or about −1° C. or about 0° C. or about 1° C. or about 2° C. or about 3° C. or about 4° C. or about 5° C. or about 6° C. and about 7° C. In particular embodiments, the temperature range is between about −10° C. and about 7° C., or between about −8° C. and about 6° C., or between about −6° C. and about 5° C., or between about −5° C. and about 4° C.

The liquid pre-mix and the dry pre-mix are combined at the chilled temperature ranges specified above. The chilled temperature may be the same as or different from the temperature range to which the pre-mixes were adjusted prior to combining them; however, the temperatures remain within the ranges set forth above. The dry pre-mix is placed in a mixer, preferably a low shear mixer, and the liquid pre-mix is slowly added while stirring to form a pourable paste. This step also may be performed by hand. The steps can be reversed, i.e., the dry pre-mix can be added to the liquid pre-mix. The inventors have determined that gentle mixing, i.e., at low shear, combined with the designated temperature environment, results in formation of an easily managed, pourable paste, rather than a viscous, sticky paste that would be difficult to handle.

At this stage, the pourable paste can be leavened mechanically. Additionally, a wide variety of inclusions may be added to the pourable paste, ranging up to, e.g., 80% of the paste by weight. Such inclusions are selected to customize the edible composition, for instance, as a treat for a dog, cat, or other companion animal. They may comprise, but are not limited to: nuggets of jerky, dried liver, dried fruit, extruded semi-moist petfood, breakfast cereal, crushed biscuits, dried meat analogs, dried vegetables/semi-moist vegetables, and granules or liquid additives of palatant materials.

The pourable paste is poured into a heat stable container, such as a mold, pan or similar container suitable for heating. Alternatively, as described in greater detail below, the pourable paste is poured into its final packaging material.

The heat stable container holding the pourable paste is heated for a time and at a temperature suitable to produce a cooked product, i.e., by melting the paste components together. Such heating is well known to the skilled artisan, who understands that the combination of time and temperature produces the cooked product. Thus, heating time varies with temperature, mixture formulation, design of the container, and design of the heating apparatus. In one embodiment, the paste is baked in an oven at75° C. to 90° C. for 0.3 hrs to 3 hours until the mixture melts. The melted mixture is then cooled, with the resultant composition being transparent, translucent or opaque and comprising a chewy, rubbery consistency.

During heating, the leavening agent facilitates a dramatic expansion of the pourable paste to the point of foaming in its physical appearance. The exact degree and size of the foaming bubbles depends on the leavening agent chosen. Care must be taken to avoid overheating, which occurs when the mixture formulation degasses under prolonged heat exposure at high temperatures, causing the composition's foamy, opaque texture to dissipate and resemble a high-density translucent substance.

Alternatively, degassing may also be advantageously manipulated to form a hybrid-textured chewy composition comprising a foamy, low-density, opaque layer atop a translucent or transparent high-density base layer. In one embodiment, the dual-density layer is formed by locally applying heat to achieve a desired degree of either transparency or translucency. Each density layer may be sized accordingly and any number and/or combination of layers may be formed in the fmal treat structure. At least one of the foamy, opaque layer or the high-density translucent layer may be entrapped with inclusions and final multi-layer structure may be further processed by encasing in jerky or the like.

The mixture formulation is then cooled, with the resultant composition being transparent, translucent, opaque or a combination thereof and comprising a chewy, rubbery consistency. If cooled rapidly, the composition will hold its shape across the width of its mass. If cooled slowly, the composition will likely collapse in the center of its mass. In the latter, the indented middle creates a unique shape and texture that is raised around the edges of the mass and collapsed in the center. As a result, the collapsed center may be used as a storage cavity for another layer of edible material, e.g., the dense, chewy edible material that is formed by combining the above-described components without inclusion of a leavening agent, an icing sugar or wheat gluten mixture, to name just a few.

The composition is then removed from the heat-stable container, optionally rolled in a dusting agent and typically, but optionally, divided into an appropriate shape such as bars, small cubes or any other desired shape, depending on the application. For example, for items that may be consumed in a short duration (i.e. in as little as 30 seconds), products typically have a maximum size of 8 cm³ (e.g., 2 cm×2 cm×2 cm or some other dimension resulting in the same overall volume). It is noteworthy that the short duration treats are readily water soluble, thereby making them particularly advantageous in guarding against choking should they become lodged in the throat of the person or animal consuming them.

For edible items designed to be consumed in a longer duration, products typically have a size of between about 8 cm³ and about 40 cm³, for instance, 1-2 cm×1-2 cm×8-10 cm. Chewing duration was found to be dependent on the formula used and inclusions added. For instance, in formulas having high water or high sugar or high inclusion content, chewing duration was as low as 40 seconds, versus 5 minutes where the treat comprised solely gelatin and glycerol. The longer duration treats offer the same choking prevention advantage as the short duration treats.

It was suprisingly discovered in accordance with the present invention that the chewy edible compositions made with leavening have a longer chewing duration than do similar compositions made without leavening. For example, a chewy composition made with leavening, having a size of about 10 cm³ had a chewing duration of about 90 seconds as compared with about 40 seconds for an unleavened version of the same size. As another example, a pet treat composition prepared with leavening as described herein weighing 30g can, in some instances, take a medium-sized dog (such as a beagle) up to 40 minutes to chew. This is advantageous for several reasons. First, chewing enjoyment can be extended at a lower cost, since the expanded composition contains comparatively less material than its unleavened counterpart. Second, chewing can be enjoyed for a longer duration while consuming fewer calories, for the same reason.

As mentioned above, gelatin is the collagen derivative typically used in practice of the present invention. However, collagen itself can be used as an alternative to gelatin. Gelatin is sometimes difficult to source or is the result of a costly synthesis. Collagen is a less expensive and more natural alternative and can be obtained by extracting it directly from bone, skin or other natural collagen sources.

In once process, bone, skin or other lean collagen sources can be cut into small, discrete chunks and placed in a cooker, preferably a pressure cooker. The collagen source is then covered with a mixture of desired glycerol, optionally water, and optionally, organic acid (e.g., acetic acid). The desired amounts of glycerol and water may be, for example, chosen from one of the formulations above.

The mixture is heated to between 80° C. to 120° C. for 30 to 60 minutes and then filtered while hot. After cooling the filtrate to less than 10° C., any residual fat from the collagen source can be removed. The filtrate is then transformed into the pourable paste by adding at least one of water (if not added previously), sugar, additional glycerol, sorbic acid and mixing in a low shear at about −15° C. to about 7° C., or preferably, about −5° C. to about 4° C., as described above

Examples of bone types include trimmed beef hooves, lamb trotters or swine trotters. It is preferred the hooves or trotters be pickled for improved collagen extract quality. A combination of degreased skin and rawhide may be substituted for the bone in a ratio of approximately one part degreased skin to three parts rawhide. Another alternate formulation for the base stock is using ligaments or tendons from beef cattle, kangaroo, ostrich, and any other suitable animal as the collagen source.

In certain embodiments, the chewy edible composition can be further customized as a pet treat by configuring it in a sandwich-like arrangement alongside one or multiple thin sheets of jerky; however, other materials including dried ham, dried sliced chicken, dried sliced turkey, dried sliced pork, sliced Biltong, dried sliced liver, any other analogous sliced meat, biscuits, and saltines may be used as a substitute.

Preparation of the jerky material can be performed in accordance with known methods. For instance, a low fat source of meat is cooled to a temperature less than −5° C., preferably −18° C., then minced and blended with at least one of dextrose, salt, maltodextrin, sugar, wheat protein, glycerol, antioxidants (e.g., RENDOX™, NATUROX™), sorbic acid, smoke aroma and sodium nitrite. Each of the blended ingredients may be pre-cooled to a temperature less than −5° C., preferably −18° C. The meat source may include reduced-fat beef rump, kangaroo, emu, crocodile, mechanically deboned turkey, mechanically deboned chicken and squid tubes.

This mixture is placed in a block mold (e.g., approximately 0.5 m×1 m×0.2 m where it is pressed and degassed under gentle vacuum. After vacuum treatment, the block is cooled at less than −18° C. for at least 24 hours after which time it is thinly sliced into sheets (e.g., approximately 2 mm thick). The slices are then placed onto mesh trays and loaded into a pre-heated oven and dried, e.g., at 80° C. to 90° C. for about 40 minutes to 3 hours. Timing may be optimized for specific oven characteristics and also manipulated depending on exact temperatures used. For example, drying may also occur for a longer period of time at lower temperatures.

After removing from the oven, the dried sheets are cooled. For jerky being used as bookends in a sandwich-type treat, the slices are pierced multiple times such that the sheets comprise holes 0.5 mm to 1.0 mm in diameter.

For a single faced sandwich, the slices are placed at the bottom of a mold or tray and the above pourable paste is poured into the mold or tray over the top of the sliced jerky. To facilitate layer binding between the jerky slice and the paste as it cooks, a porous layer of dried meat, expanded biscuit, expanded cereal based material, dried fruit, dried vegetable, fruit leather or jerky may be added as an interface.

If desired, a second sheet of jerky may be placed over the top of the pourable paste. The second sheet is gently pressed to force paste mixture to penetrate the holes of the second sheet of jerky. This is conducted prior to the heating step. Pressure may also be maintained during the subsequent heating step. Exact time and temperature is relative to thickness of the paste-jerky combination and oven characteristics. During the heatng, the paste may expand into the jerky holes to ensure binding of the two layers. The resultant product is removed from the heating source, cooled, and then optionally cut into a shape and size for the desired application, i.e. as a short duration or longer duration treat. The items may be subsequently coated or enrobed with another component suitable for the target consumer.

Once completely formed, the chewy edible compositions, in whichever formulation described above, can be packaged for sale. One option is to perform the heating step by pouring the pourable paste into packaging designed for the consumer end user. Appropriate packaging material should be heat-stable, for instance, capable of surviving temperatures greater than 90° C. for at least 2 hours. Preferably, the material should be able to survive temperatures ranging from 90° C. to 97° C. for at least 2 hours. Suitable packaging materials include, but are not limited to, polyacrylate and derivatives thereof, high density polyethylene (HDPE); polypropylene (PP); polyvinylchloride (PVC); polyethylene terephthalate (PET); polystyrene (PS); high impact polystyrene (HIPS); Polyamide (PA), or combinations of such materials. Storage studies have shown stable and palatable products lasting up to 3 years using a polyacrylate type of packaging material.

Packaged products may be transparent, translucent, or opaque with multiple potential shapes including small cubes or any other molded shape. Colors of the final product may include clear, white, or brown, depending on the ingredients used (e.g, the type of sugar used in the formulation influences the appearance of the final product). Furthermore, dyes of any color may be selected to enhance appearance, palatability, and consumer interest and appeal.

The process described above can be adapted to produce a chewy edible composition with an expanded, porous or dual texture, for any purpose. In a preferred embodiment, the edible composition is formulated as a pet treat for a dog, cat or other companion animal. However, edible compositions can also be formulated for human consumption, such as by an adult or a child.

Another aspect of the invention features a pourable paste for producing a chewy edible composition of the present invention. The pourable paste comprises a humectant, such as glycerol and/or the other humectants described above, and collagen or a collagen derivative, among other optional ingredients, including a leavening agent, as described above. In particular embodiments, the paste comprises less than 50% water as described above. In other embodiments, the pourable paste comprises less than 30% water. Pourability of the paste is achieved by chilling a liquid pre-mix comprising the glycerol, and a dry pre-mix comprising the collagen, gelatin or other collagen derivatives, at the specified temperature range outlined above, and then mixing the pre-mixes together at the same temperature range, using a low-shear mixing process. As used herein, the term “pourable” means that the paste is of sufficiently low viscosity and stickiness that it can be poured or spooned into another container, such as a heat-stable container, without undue difficulty.

The content of humectant and collagen or collagen derivative is as described above. In certain embodiments, the pourable paste comprises between about 15% and about 40% glycerol, between about 20% and about 65% gelatin, and between abouts 0% and about 50% water, optionally comprising sugar or a sugar alcohol.

The pourable paste can also contain additional ingredients over and above the optional leavening agent, including but not limited to sugar, sugar alcohols, water, pre-prepared sugar-water syrups, flavor enhancers. natural or artificial acidifying agents, antioxidants, preservatives, colorants, and other nutritional components such as starches and flour, and micronutrients such as vitamins and minerals to provide additional nutritional value to the edible composition.

Another aspect of the invention features a chewy edible leavened composition with expanded or multiple textures, comprising glycerol, or a substitute therefore as described above, and collagen or a collagen derivative such as gelatin, and about 25% or less water. In certain embodiments, the composition is substantially free of water. The compositions typically comprise between about 25% and about 70% collagen or collagen derivative, between about 20% and about 50% humectant such as glycerol, between about 0% and about 25% water, and optional sugar or sugar alcohol. Examples of the components of certain embodiments of the chewy edible leavened compositions are set forth in the Examples.

The chewy edible compositions of the present invention are distinct from gelatin films, such as those used to produce gel-caps, for instance. Such films typically are softer and more pliable than the compositions of the invention, due in part to inclusion of substances that can interefere with the binding and/or toughness of the material, or higher amounts of such substances than included in the present compositions. Moreover, the chewy edible composition of the present invention has a solid, partially or fully porous, three-dimensional shape. The shape can be any desired shape that can be formed, cut or molded in the process of heating the above-described pourable paste.

In certain embodiments, the chewy edible compositions of the present invention are prepared with leavening agents, then heated and/or cooled in a manner that yields a composition with a texture that is expanded and porous across its entirety. This composition can be layered with other materials, as described above. In other embodiments, compositions prepared with leavening agents are heated and/or cooled in a manner that yields a dual-texture composition, as described above. In one embodiment, the dual-texture composition has a collapsed center in which is deposited another material, for instance a dense version of the composition (prepared without leavening) or another type of material entirely.

In certain embodiments, the composition is customized as a treat, such as a child's treat or a pet treat for a companion animal, such as a dog or cat. Depending on the starting formulation, the resultant edible composition can be more or less chewy. For instance, a composition with a higher sugar content, or a higher sugar to glycerol ratio (e.g., 1.7:1) can be more easily chewed than a composition with a lower sugar content or a lower sugar to glycerol ratio (e.g., 0:1). Additionally, smaller sized compositions can be chewed more quickly. Thus, the chewy edible composition can be sized for consumption by a smaller or larger individual, such as a cat as compared to a dog, or a small dog as compared to a large dog, or a child as compared to an adult. However, as mentioned above, it should be taken into account that the expanded compositions formed with leavening typically have a longer chewing duration than similar compositions formed without leavening. In one embodiment, the composition has a total volume less than about 8 cm³. In another embodiment, the composition has a total volume between about 8 cm³ and about 40 cm³. The skilled artisan will understand that other sizes appropriate to other consumers can easily be devised.

### EXAMPLES

The invention can be further detailed by the following examples, although it will be understood that these examples are included merely for purposes of illustration and are not intended to limit the scope of the invention unless otherwise specifically indicated.

### Example 1

### Pre-Mix Formulations

In one example, the liquid pre-mix contained sugar (27.5%), glycerol (27.5%), and water (15.4%) and the dry pre-mix contained gelatin (27.5%), smoke (0.1%), sorbic acid (0.3%), NATUROX™ antioxidant mix (0.1%), sodium bicarbonate (0.6%), and citric acid (1.2%).

In another example, the liquid pre-mix contained sugar (28.0%), glycerol (27.7%), and water (15.5%) and the dry pre-mix contained gelatin (27.7%), smoke (0.1%), NATUROX™ antioxidant mix (0.1%), and sodium bicarbonate (1.0%).

In another example, the liquid pre-mix contained sugar (27.5%), glycerol (27.5%), and water (15.4%) and the dry pre-mix contained gelatin (27.5%), smoke (0.1%), sorbic acid (0.3%), NATUROX™ antioxidant mix (0.1%), sodium bicarbonate (0.6%), and tartaric acid (1.0%).

In another example, the liquid pre-mix contained comprises sugar (27.1%), glycerol (27.1%), and water (15.2%) and the dry pre-mix contained gelatin (27.1%), smoke (0.1%), sorbic acid (0.3%), NATUROX™ antioxidant mix (0.1%), and baking powder (2.9%).

### Example 2

### Preparation of a Uniformly Expanded Chewy Composition

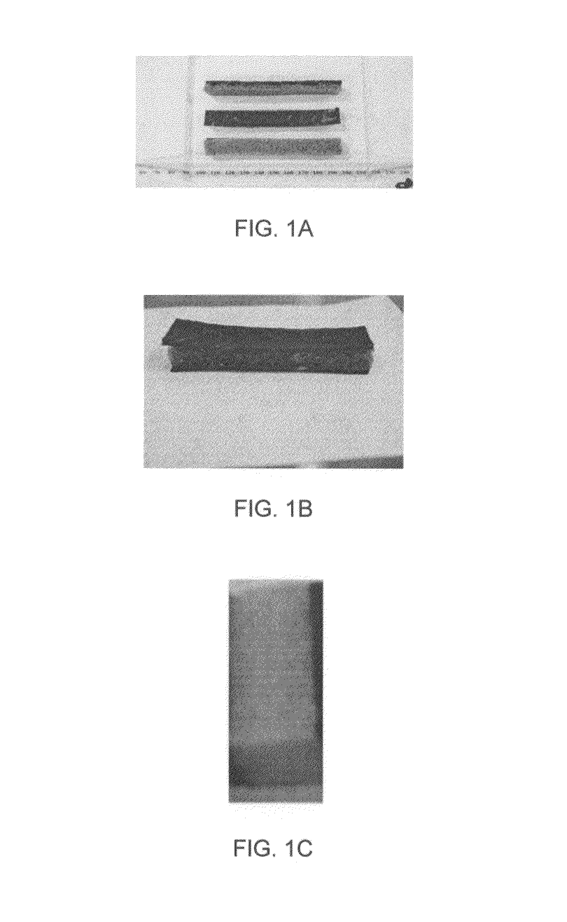

Using one of the pre-mix formulations described in Example 1, the liquid pre-mix and the dry pre-mix were chilled to between about −5° C. and 4° C., and mixed together within that temperature range, to form a pourable paste. The pourable paste was poured into a mold and heated in an oven at 75-85° C. for one to two hours to form a cooked product. The mixture expanded dramatically during the heating process. The mold containing the cooked product was removed from the oven and cooled rapidly by placing it into a freezer (temperature ˜18° C.). Quick cooling was determined to influence the degree of expansion, i.e., if the paste is cooled more slowly, such as at room temperature, more gas is lost and the expansion is reduced. The resultant chewy edible composition, which comprised a uniformly expanded, porous texture, was cut into smaller portions. An example of the composition is shown in FIG. 1.

### Example 3

### Preparation of Multi-Textured Composition using Heat Manipulation

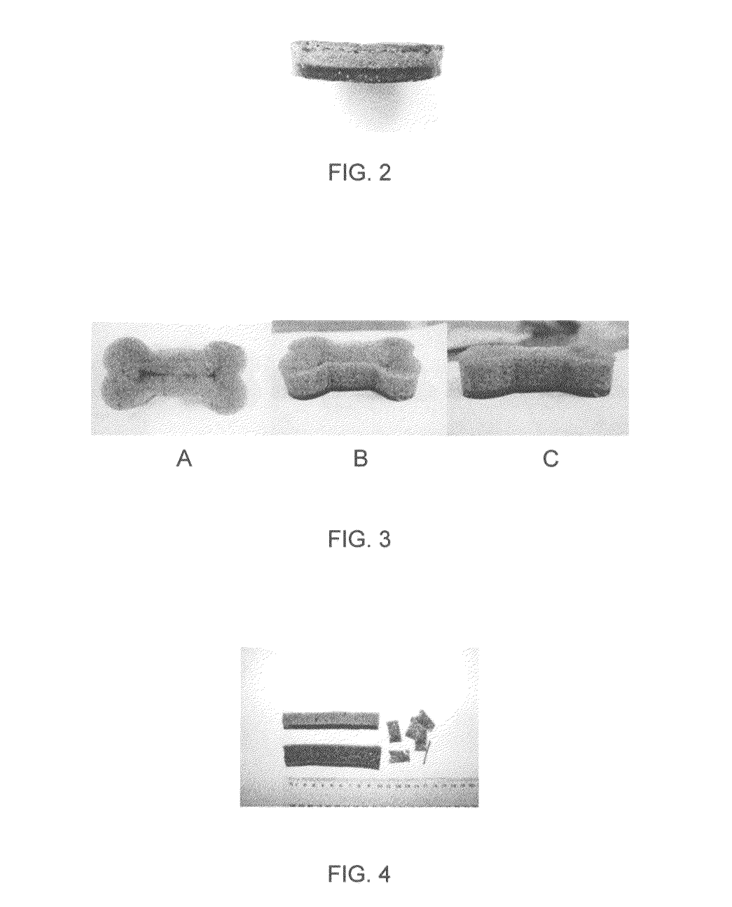

Using one of the pre-mix formulations described in Example 1, the liquid pre-mix and the dry pre-mix were chilled to between about −5° C. and 4° C., and mixed together within that temperature range, to form a pourable paste. The pourable paste was poured into a transparent mold and heated in an oven at 75-85° C. Initially, the mixture began to foam and was opaque. The heating was continued for an extended period, i.e., about 1.5 times the normal holding time at 75-85° C., and carefully monitored for the formation of a higher density layer at the bottom. When the bottom layer had become transparent or translucent to the desired extent, the mold was removed from the oven and cooled rapidly by placing in a freezer at ˜minus 18° C. until the mass sets (45-60° C.). The resultant chewy edible composition comprised a bi-layer, with the bottom layer being dense and translucent or transparent, and the top layer being porous and expanded. An example of the multi-textured chewy composition is shown in FIG. 2. These compositions can be made even more interesting by encasing or layering them with jerky or other materials, or by adding inclusions, which are readily visible in the de-gassed layer.

### Example 4

### Preparation of Multi-Textured Composition using Cooling Manipulation

Using one of the pre-mix formulations described in Example 1, the liquid pre-mix and the dry pre-mix were chilled to between about −5° C. and 4° C., and mixed together within that temperature range, to form a pourable paste. The pourable paste was poured into a small, shaped molds and heated in an oven at 75-85° C. for one to two hours to form a cooked product. The mixture expanded dramatically during the heating process. The mold containing the cooked product was removed from the oven and cooled slowly, causing the product to de-gas in the center and to collapse, forming a depression in the center. An example of the shaped composition with a depressed center is shown in FIG. 3. The center was filled with a different composition to form a multi-textured, multi-component composition.

For one filling, a dry pre-mix contained 95% icing sugar and 5% wheat gluten mixed at a 4:1 ratio with cold water to form a uniform paste. The paste was slowly heated to at least 70° C. while stirring. After cooling the paste (e.g. 45-50° C.), the mixture was poured into the center of the composition. The combination was rapidly cooled until the filler set. Optionally, meat powder (e.g. 10% ground jerky) may be added to the dry pre-mix prior to addition of the cold water.

For another type of filling, a pourable paste comprising unleavened version of the chewy composition was prepared. After the step of baking the pourable paste at about 75° C. to 90° C., the product was partially cooled (e.g. to about 45-50° C.), poured into the collapsed center of the expanded composition, and allowed to set at room temperature. Visible inclusions may be added while the filling mixture is still a liquid.

### Example 5

### Preparation of Pourable Paste Using Collagen as Starting Material

In one example, bone (collagen feedstock) (71.0%), glycerol (18.0%), water (9.0%), and acetic acid (1.0%) were placed in a pressure cooker. The mixture was heated to between about 80° C. to about 120° C. for approximately 30 to 60 minutes and then filtered while hot. After cooling, the filtrate was mixed with sugar (18.8%) in a low shear mixer within the temperature range of at about −15° C. to about 7° C., or about −5° C. to about 4° C. In the step of mixing with sugar, the filtrate comprised the balance of the total mixture (81.2%). In another example, a mix of ligament or tendon (collagen feedstock) (38.0%), glycerol (42.0%), water (14.0%) and acetic acid (5.0%) were placed in a pressure cooker. The mixture was heated to between about 80° C. to about 120° C. for approximately 30 to 60 minutes and then filtered while hot. After cooling, the filtrate was mixed with glycerol (10.0%) in a low shear mixer at about −15° C. to about 7° C., or about −5° C. to about 4° C. In the step of mixing with glycerol, the filtrate comprised the balance of the total mixture (90.0%).

### Example 6

### Formulations for Jerky Material

In one example of the jerky formulation, the initial mixture contained beef (or other animal material) (85.80%), dextrose (2.89%), salt (1.70%), maltodextrin (1.37%), sugar (1.80%), wheat protein (2.50%), glycerol (3.50%), antioxidant mix (RENDOX™ or NATUROX™) (0.10%), sorbic acid (0.30%), smoke aroma (0.02%), and sodium nitrite (0.02%).

In another example of the jerky formulation, the initial mixture contained beef (or other animal material) (82.30%), dextrose (2.89%), salt (1.70%), maltodextrin (1.37%), sugar (1.80%), wheat protein (2.50%), glycerol (7.00%), antioxidant mix (RENDOX™ or NATUROX™)(0.10%), sorbic acid (0.30%), smoke aroma (0.02%), and sodium nitrite (0.02%).

In another example of the jerky formulation, the initial mixture contained beef (or other animal material) (78.60%), dextrose (2.89%), salt (1.70%), maltodextrin (1.37%), sugar (1.80%), wheat protein (2.50%), glycerol (10.70%), antioxidant mix (RENDOX™ or NATUROX™) (0.10%), sorbic acid (0.30%), smoke aroma (0.02%), and sodium nitrite (0.02%).

### Example 7

### Formulations and Methods for Highly Palatable Pet Treats

In one example, the liquid pre-mix contained salmon and tuna digest/slurry made from salmon and tuna frames (33.83%), sugar (35.52%), Snow Gum brand liquid smoke (0.27%), potassium chloride (0.37%) and salt (1.69%). The poweder pre-mix contained gelatin (27.06%), sodium bicarbonate (1.01%) and sorbic acid (0.24%).

In another example, the liquid pre-mix contained lamb digest/slurry made from mechanically de-boned lamb (33.83%), sugar (35.52%), Snow Gum brand liquid smoke (0.27%), potassium chloride (0.37%) and salt (1.69%). The poweder pre-mix contained gelatin (27.06%), sodium bicarbonate (1.01%) and sorbic acid (0.24%).

In another example, the liquid pre-mix contained chicke digest/slurry made from chicken frames (33.83%), sugar (35.52%), Snow Gum brand liquid smoke (0.27%), potassium chloride (0.37%) and salt (1.69%). The poweder pre-mix contained gelatin (27.06%), sodium bicarbonate (1.01%) and sorbic acid (0.24%).

The liquid pre-mix was prepared by mixing glycerol, salmon or meat digest, sugar, potassium chloride and sodium chloride. The mixture was gently warmed to ensure the sugar and salts were dissolve. This liquid pre-mix was chilled to 4° C. The dry mix was prepared by mixing sorbic acid, gelatin and sodium bicarbonate also chilled to 4° C.

The dry pre-mix was placed in a low shear mixer and the mixer turned on. The liquid pre-mix was slowly introduced and thoroughly mixed to form a cold, pourable paste. The pH of this paste was checked and adjusted to ensure a pH of 4.8 to 5.2.

The cold paste was poured into shallow trays to a depth of 7 mm and placed into oven pre-heated to ˜75° C.

The trays were left in the oven until the paste had melted and risen to over double its initial volume, which typically took about 2 hours. The trans were removed from the oven and immediately placed in a cool room and the cooked paste rapidly cooled.

The product comprised a soft rubbery solid foam filled gas bubbles. It had the appearance of a brown Swiss cheese and the texture of a sponge slab. It had an appetizing smoked salmon or meat aroma. These sheets of product were cut to form a variety of treats, as shown in FIG. 4.

For cats, the sheets were guillotined to form short bars and then further cut to form thin slices ˜1-2 mm thick×10 mm×5 mm. Cats found the treats highly palatable. For example, in a room filled with 40 cats, 2 large trays were placed on the floor, one filled with ˜80 of the above treats and the other with the same amount of a commercially available cat treat. All cats immediately swarmed around the tray with the invention treats with cats fighting to get access to the treats. The other tray was nearly totally neglected with only a couple of the other treats eaten by low dominance cats that could not get access to the treats of the invention.

For dogs, the sheets were guillotined to form short bars 7-10 cm long×1-1.5 cm thick by 1 cm wide. This treat when fed to dogs was very well accepted and rapidly eaten.

An added advantage to the pet treats described in this example is that they are very shelf-stable as compared with conventional treats containing animal digests.

In another embosiment, the present invention can be used as a palatability enhancer to coat dry or semi-moist pet food kibbles. In one example, the kibbles were enrobed by spraying about 5% of the solidified product that was melted at about 65° C. Alternatively the cold paste may be used in place of the melted solidified product. The enrobed kibbles were then rapidly cooled by a forced air stream at ambient temperature to solidify the coating and prevent caking. Significant animal preference was shown for the solid coated kibbles compared to kibbles coated by the current standard palatability enhancer.

The present invention is not limited to the embodiments described and exemplified above. It is capable of variation and modification within the scope of the appended claims.

What is claimed is:

1. A method for preparing a chewy edible composition, comprising:
preparing a liquid pre-mix by mixing a humectant with other liquid ingredients, if any;
preparing a dry pre-mix by mixing collagen or a collagen derivative with an optional leavening agent and other dry ingredients, if any;
chilling the liquid pre-mix and the dry pre-mix to a temperature between about −15° C. to about 7° C.;
mixing the liquid pre-mix with the dry pre-mix at a temperature between about −15° C. to about 7° C. to form a pourable paste;
optionally, mechanically leavening the pourable paste, provided that a leavening agent is not added to the dry pre-mix;
pouring the paste into a heat-stable container;
heating the container at a temperature and for a time sufficient to produce a cooked paste; and
cooling the cooked paste to form the chewy edible composition.

2. The method of 1, wherein the chilling step or the mixing step, or both, are performed at a temperature between about −5° C. and about 4° C.

3. The method of claim 1, wherein the liquid pre-mix further comprises water or an aqueous solution of sugar or a sugar alcohol and water, wherein the water is present in an amount less than about 50% of the paste.

4. The method of claim 3, wherein the water is present in an amount less than about 30% of the paste.

5. The method of claim 1, wherein the humectant is selected from glycerol, erythritol, 1,2-propanediol, ethanol and sorbitol, or combinations thereof.

6. The method of claim 1, wherein the collagen derivative is gelatin.

7. The method of claim 1, wherein the dry pre-mix includes a leavening agent.

8. The method of claim 7, wherein the leavening agent produces carbon dioxide.

9. The method of claim 1, wherein the heat-stable container is a baking mold.

10. The method of claim 1, wherein the heat-stable container comprises packaging material.

11. The method of claim 1, wherein the heating and cooling are performed under conditions resulting in a uniformly porous chewy edible composition.

12. The method of claim 1, wherein the heating is performed under conditions resulting in a multi-density chewy edible composition comprising a de-gassed dense layer and a porous layer.

13. The method of claim 1, wherein the cooling is perfomed under conditions resulting in a partially collapsed, partially expanded, chewy edible composition.

14. The method of claim 1, comprising separating the chewy edible composition into portions.

15. The method of claim 1, wherein the chewy edible composition is formulated as a pet treat.

16. The method of claim 15, wherein the composition comprises additional pet treat components.

17. The method of claim 16, wherein the additional pet treat components are mixed in with the paste or layered underneath and/or on top of the paste prior to cooking.

18. A chewy edible composition, at least a portion of which comprises an expanded, porous texture, produced by the method of claim 1.

19. The composition of claim 18, which is a pet treat.

20. A pourable paste for producing a chewy edible composition, the paste comprising a humectant, collagen or a collagen derivative and a a leavening agent, wherein the paste comprises less than about 50% water.

21. The paste of claim 20, comprising less than 30% water.

22. The paste of claim 20, wherein the humectant is glycerol, the collagen derivative is gelatin and the leavening agent produces carbon dioxide.

23. The paste of claim 20, comprising between about 15% and about 40% glycerol, between about 20% and about 65% gelatin, and between abouts 0% and about 50% water, optionally comprising sugar or a sugar alcohol.

24. The paste of claim 20, further comprising at least one palatant for a dog or cat.

25. A chewy edible composition comprising glycerol and gelatin, comprising less than about 20% water, at least a portion of which comprises an expanded, porous texture.

26. The composition of claim 25, further comprising sugar or a sugar alcohol.

27. The composition of claim 25, having a solid, three-dimensional shape, at least part of which is porous.

28. The composition of claim 25, which is a uniformly porous chewy edible composition.

29. The composition of claim 25, which is a multi-density composition comprising a de-gassed dense layer and a porous layer.

30. The composition of claim 25, comprising a collapsed center portion and an expanded, porous peripheral portion.

31. The composition of claim 25, formulated as a pet treat.
